(19) United States
(12) Patent Application Publication
(10) Pub. No.: US 2007/0268992 A1
(43) Pub. Date: Nov. 22, 2007

(54) Method and system for providing packet data services

(76) Inventors: Stuart Owen Goldman, Scottsdale, AZ (US); Douglas Harold Rollender, Bridgewater, NJ (US)

Correspondence Address: HARNESS, DICKEY & PIERCE, P.L.C., P.O. BOX 8910, RESTON, VA, 20195, US

(21) Appl. No.: 11/436,563

(22) Filed: May 19, 2006

(51) Int. Cl. G21C 1/04

(52) U.S. Cl. 376/351

(57) ABSTRACT

In one embodiment, communication from a user device is recognized as a service request, and in response, a surrogate home system is invoked without accessing a home system for the user device. The surrogate home system is configured to handle connecting the user device with a provider of the service requested.

### BACKGROUND OF THE INVENTION

1. Field the of the Invention

The present invention relates to a method and system for providing packet data services.

2. Description of Related Art

FIG. 1 illustrates a portion of a system architecture for a next generation network (NGN) and its relationship with a packet technology based call controller (e.g., an IP multimedia subsystem (IMS) as shown). As shown, a mobile station or user equipment (UE) 10 communicates with a visited access network (ANC) 12 as shown or a home ANC 14. The terms mobile station and user equipment will be used interchangeably and generically throughout this application as any device (phone, PDA, computer, etc.) capable of wireless or direct connection communication, and should not be interpreted as limited to a particular standard. As will be appreciated from the description below, in FIG. 1 the ANCs 12 and 14 includes the radio access network and core network components to communicate, for example, packet data with mobile stations such as mobile station 10, and to send and receive packet data over a packet data network (PDN) 18. The home ANC 14 is the system with which the mobile station 10 has subscribed to handle communications services. The visited ANC 12 is a system in which the mobile station 10 is currently located, and the system that is currently handling the communication needs of the mobile station 10. As will be appreciated, multiple ANCs may be connected to the PDN, but have not been shown for the sake of clarity.

Generally, in order for the visited ANC 12 to handle communication for the mobile station 10, the visited ANC 12 sends the call information for the mobile station 10 to the home ANC 14. The home ANC 14 stores management information regarding the mobile station 10 (because the mobile station 10 has subscribed with the home ANC 14) that allows the home ANC 14 to validate the mobile station 10 and provide feature information back to the visited ANC 12. The feature information may indicate features to which the mobile station 10 has subscribed. Once the visited ANC 12 validates the mobile station 10, the visited ANC 12 sends, for example, VoIP bearer traffic received from the mobile station 10 to the PDN 18. It will be appreciated that multiple PDNs may exist, but a single PDN has been shown for the sake of clarity. The PDN 18 routes the VoIP traffic through the home ANC 14 or other ANCs (not shown) to other mobile stations (not shown). Alternatively, the PDN 18 routes the VoIP traffic to an end point 28 connected to the PDN. The end point 28 may be a computer connected to the internet, a VoIP phone directly connected to the PDN 18, etc. It will be appreciated that the end point 28 may be connected to the PDN 18 through an IP service provider (not shown for the sake of clarity). Alternatively, the VoIP bearer traffic is routed to a media gateway (MGW) 20. The MGW 20 converts the VoIP bearer traffic to a suitable communication format for a public switched telephone network (PSTN), and routes the converted voice call over a PSTN 24. The PSTN 24 connects the call to an end point 26 such as a telephone connected to the PSTN 24. Similarly, the MGW 20 may convert communication from the PSTN 24 into a packet data for routing over the PDN 18

For purposes of explanation only, the VoIP session will be described as being between the mobile station 10 and the end point 26. The call control path between the mobile station 10 and the end point 26 traverses the ANC 12, the PDN 18, the IMS 22, and the PSTN 24. The ANC 12 and the PDN 18 support transport of IP packets with the appropriate quality of service (QoS) and do not otherwise influence signaling messages on the call control path or bearer traffic on the bearer path.

The routing within the PDN 18 is managed by a packet call controller such as an IP multimedia subsystem (IMS) 22 as defined in 3GPP TS 23.228 and related specifications, and shown in FIG. 1. For example, the IMS 22 serves as a proxy for the SIP signaling related to the VoIP session between the mobile station 10 and the end point 26. Throughout this disclosure, examples of SIP signaling are according to the well-known SIP protocol version 2.0, defined in IETF RFC 3261 and related specifications.

Similarly, the end point 26 may communicate packet data (e.g., VoIP), with the end point 28, another end point 26 or the mobile station 10. And, the end point 28 may communicate packet data (e.g., VoIP), with another end point 28, the end point 26 or the mobile station 10. Generally, in order for the visited ANC 12 to handle communication for the mobile station 10, the visited ANC 12 sends the call information for the mobile station 10 to the home ANC 14. The home ANC 14 stores management information regarding the mobile station 10 (because the mobile station 10 has subscribed with the home ANC 14) that allows the home ANC 14 to validate the mobile station 10 and provide feature information back to the visited ANC 12. The feature information may indicate features to which the mobile station 10 has subscribed.

While this method of handling packet data communication from a mobile station 10 at a visited ANC 12 is acceptable in most instances, it may be desirable to handle certain types of calls such as certain requests for a particular service (e.g., emergency service) regardless of validation.

### SUMMARY OF THE INVENTION

The present invention relates to a method of providing packet data services.

In one embodiment, communication from a user device is recognized as a service request, and in response, a surrogate home system is invoked without accessing a home system for the user device. The surrogate home system is configured to handle connecting the user device with a provider of the service requested.

In one embodiment, an identifier is received with the communication from the user device, and whether the communication is a service request is determined based on the identifier. For example, service offerings may be sent to the user device along with associated service identifiers, and the user device returns one of the associated service identifiers.

In one embodiment, the method further includes selectively obtaining, at the surrogate home system, service related information; and directing, by the surrogate home system, communication from the user device to a provider of the service requested along with the obtained service related information. For example, the communication may be directed over a packet data network.

According to another embodiment of the method of providing packet data services, communication from a user device is directed over a packet data network to a provider of a requested service without accessing a home system for the user device.

The present invention also relates to a system for providing packet data services.

In one embodiment, the system includes a visiting system and a surrogate system. The visiting system may recognize a communication from a user device as a service request. The visiting system is not a home system for the user device, and the visiting system invokes the surrogate home system without accessing a home system for the user device if the visiting system recognizes the communication as a service request. The surrogate home system is configured to handle connecting the user device with a provider of the service requested.

In one embodiment, the surrogate home system forms part of the service provider.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a portion of a system architecture for a next generation network (NGN) and its relationship with a packet technology based call controller (e.g., an IP multimedia subsystem (IMS) as shown).

FIG. 2 illustrates a portion of a system architecture for a next generation network (NGN) and its relationship with a packet technology based call controller (e.g., an IP multimedia subsystem (IMS) as shown) according to an embodiment of the present invention.

FIG. 3 illustrates operation performed by the visited ANC in FIG. 2 with respect to received calls that may be service requests according to an embodiment of the present invention.

FIG. 4 illustrates an example embodiment of a process by which a mobile station sends a service identifier to the visited ANC of FIG. 2 with the assistance of the visited ANC.

FIG. 5 illustrates operation performed by the surrogate home system in FIG. 2 with respect to service requests according to an embodiment of the present invention.

FIG. 6 illustrates an example of an emergency service provider system as the service provider in FIG. 2.

### DETAILED DESCRIPTION OF EMBODIMENTS

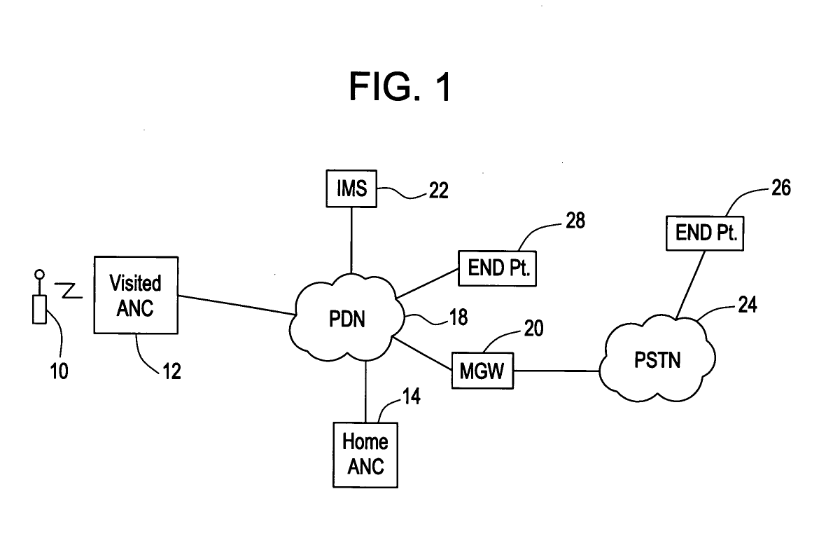

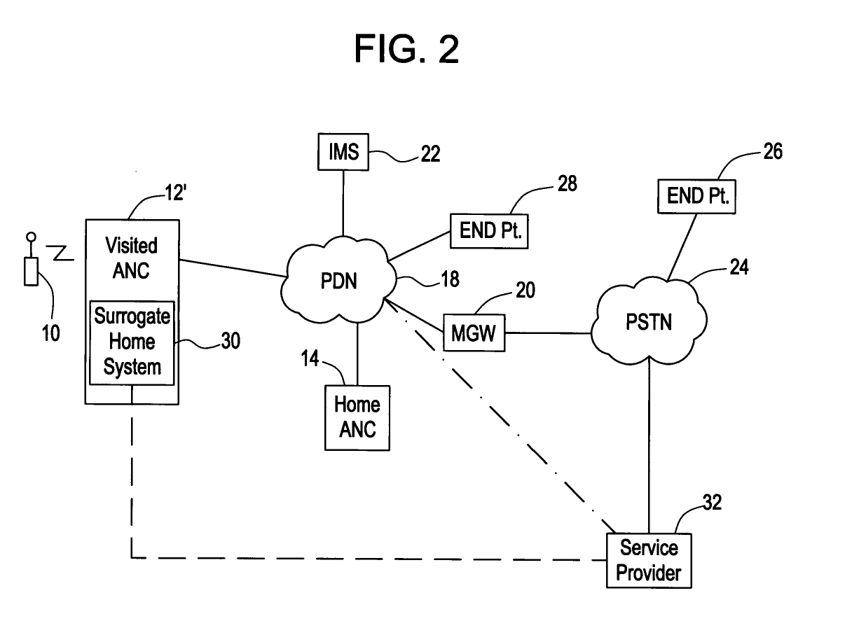

FIG. 2 illustrates a portion of a system architecture for a next generation network (NGN) and its relationship with a packet technology based call controller (e.g., an IP multimedia subsystem (IMS) as shown) according to an embodiment of the present invention. The embodiment of FIG. 2 is the same as the embodiment of FIG. 1 except for the addition of a service provider 32 and the replacement of the visited ANC 12 with a visited ANC 12′.

The visited ANC 12′ of FIG. 2 is the same as the visited ANC 12 of FIG. 1 except that the visited ANC 12 further includes a surrogate home system 30, the operation of which will be described in greater detail below. Furthermore, while this embodiment of the present invention shows the surrogate home system 30 forming part of the visited ANC 12′, the surrogate home system 30 may be separate from the visited ANC 12′. Also, the surrogate home system 30 may form part of the service provider 32 or the IMS 22. This will be described in greater detail below. If independent from the visited ANC 12′, the surrogate home system 30, may directly connect to the visited ANC 12′ or indirectly connect with the visited ANC 12′ via the PDN 18. In either case, as well as in the embodiment shown in FIG. 2, the surrogate home system 30 may connect to the PDN 18 independent of the visited ANC 12′. Furthermore, while FIG. 2 only illustrates one surrogate home system, many surrogate home systems may be included in the system architecture of FIG. 2 as discussed in detail below.

The service provider 32 provides a service such as emergency services, pizza delivery, restaurant guide, doctor/dentist locator, etc. For the sake of example only, emergency services will be used as an example in describing the operation of the present invention in detail.

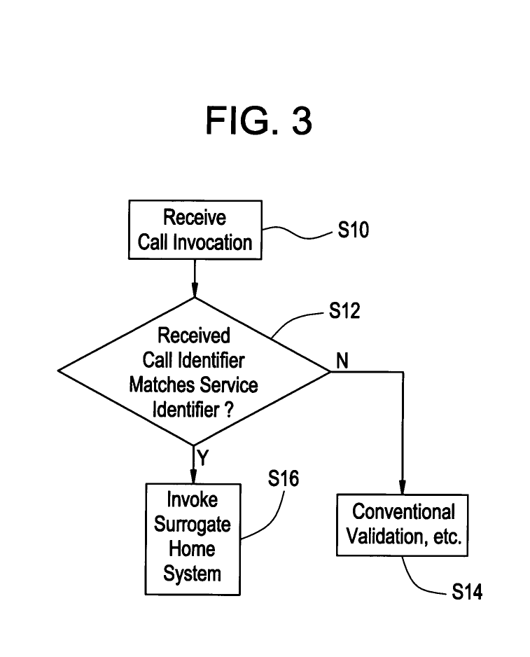

Next, the operation of the present invention will be described in detail with respect to the flow charts illustrated in FIGS. 3-5. FIG. 3 illustrates operation performed by the visited ANC 12′ with respect to received calls that may be service requests according to an embodiment of the present invention.

As shown in FIG. 3, in step S10 the visited ANC 12′ receives a call invocation or set-up request from a mobile station 10 that does not have a subscription with the visited ANC 12′. The call invocation includes an identifier such as a telephone number, an IP address, an email address, URL, etc. Often, the identifier is a destination identifier identifying a destination to which the call should be routed. However, in accordance with the principles of the present invention, the identifier may be a service identifier or treated as a service identifier, and identify a service being requested by the mobile station 10. The visited ANC 12′ stores a list of possible service identifiers, and determines in step S12 if the received call identifier matches a service identifier on the list. If no match exists, then in step S14, the call is handled in the conventional manner discussed briefly in the background of the invention section. However, if the call identifier does match one of the service identifiers, then in step S16, the visited ANC 12′ invokes the surrogate home system 30 to handle the call. Accordingly, the visited ANC 12′ does not access the home ANC 14 for the mobile station 10 to perform validation, etc.

As will be appreciated, the call identifier for emergency services in the United States may be the telephone number 9-1-1. However, the visited ANC 12′ may be equipped to recognize other call identifiers as service identifiers for emergency services.

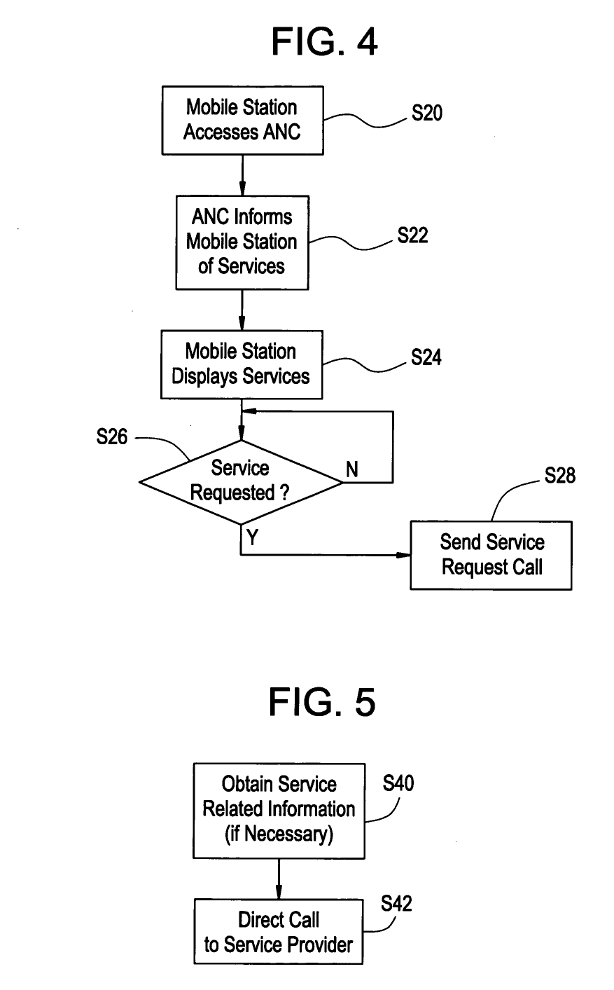

Besides sending a service identifier unilaterally, the mobile station 10 may send the service identifier in cooperation with the visited ANC 12′. FIG. 4 illustrates an example embodiment of a process by which a mobile station sends a service identifier to the visited ANC 12′ with the assistance of the visited ANC 12′. As shown, in step S20, the mobile station 10 requests access to the visited ANC 12′. As is known, when the mobile station 10 requests access, the visited ANC 12′ provides the mobile station 10 with a temporary IP address. In addition to this, in step S22, the visited ANC 12′ may also offer services available through the PDN 18. For example, the visited ANC 12′ may inform the mobile station 10 of available services including those available from one or more associated surrogate home systems. Some of the services offered by the visited ANC 12′ or associated surrogate home systems may be based on the geographic location of the mobile station 10. This implies that, in some embodiments of this invention, the visited ANC 12′ may have some information about the specific geographic location of the mobile station 10 or the serving radio base station or access point, which is part of the visited ANC 12′, in order to identify which of possibly many available services may be most appropriate to offer a mobile station 10 before a call is invoked.

It will further be appreciated that if multiple surrogate home systems exist, the surrogate home systems may be associated with different services. However, more than one surrogate home system may be associated with the same service. Also, a surrogate home system may be associated with more than one service. Accordingly, the surrogate home system that the visited ANC 12′ invokes or directs communication from the mobile station 10 to will depend on the service requested. Additionally, it will be appreciated that the visited ANC 12′ may also use other factors such as location of the mobile station 10, etc. in deciding which surrogate home system to invoke.

In one embodiment, the visited ANC 12′ provides the mobile station 10 with a text description and/or icon for each service and may also provide an service identifier for each service. The mobile station 10 may display the text and/or icon description of each service in step S24 of FIG. 4. The user need only select the displayed text or icon to request the service. In step S26, the mobile station 10 determines if the user has selected a service. If so, then based on the user selection, the mobile station 10 returns the associated service identifier to the visited ANC 12′ in step S28. The visited ANC 12′ treats this return communication as a received call invocation in step S10 of FIG. 3.

As another alternative, the service offer from the visited ANC 12′ may provide an open data entry field that is displayed by the mobile station 10. The user of the mobile station 10 may enter a telephone number, or other identifier, which is then returned to the visited ANC 12′. For example, the user could enter “pizza” to communicate an order to the local pizzeria or “gas” to find the location of the nearest gas station. As another example, the user may enter “SOS” into the open data entry field to obtain emergency services. The visited ANC 12′ receives this data entry in step S10 as a call invocation, and then determines in step S12 if the data entry matches a service identifier. In the example given, the visited ANC 12′ may recognize “SOS” as a request for emergency services the same as if the user had entered 9-1-1.

FIG. 5 illustrates operation performed by the surrogate home system 30 with respect to service requests according to an embodiment of the present invention. As shown, in step S40 the surrogate home system 30 obtains information related to the requested service that may be needed by the provider of the service requested. The service related information may be obtained by a query process with the user of the mobile station 10, may be obtained without user intervention from the mobile station 10, may be obtained from the visited ANC 12′ or other associated system element that provides the required information.

For example, if emergency services (e.g., a 911 call) is requested, then the surrogate home system 30 is responsible for obtaining the location of the mobile station 10 either from the mobile station 10, the visited ANC 12′ or other functional element in or associated with the radio access network (RAN) handling communication for the mobile station 10. The surrogate home system 30 also obtains the temporary IP address, a callback number, call identity key, and/or etc. for the mobile station 10 from the visited ANC 12′. As will be appreciated, some services may not require that the surrogate home system 30 obtain service related information. Also, it will be appreciated that the service related information will generally depend on the service requested. For example, location based services like pizza delivery or locating doctors in the area, will generally require the surrogate home system 30 to obtain the location information as with emergency services.

Referring to FIG. 5, after obtaining the service related information, the surrogate home system 30 directs the call to the service provider (e.g., service provider 32 in FIG. 2) via the PDN 18 in step S42. The address needed to request emergency service is known in advance to the surrogate home system 30. Alternatively, the address may be retrieved from a list of addresses for services offered to the public that are generally available like emergency services.

The PDN 18 delivers the emergency service request to the appropriate service provider such as service provider 32 along with the service related information. The service provider may then enter into communication with the mobile station 10 to provide the requested service.

As will be appreciated, the surrogate home system 30 does not access the home ANC 14 to direct the communication 10 over the PDN 18.

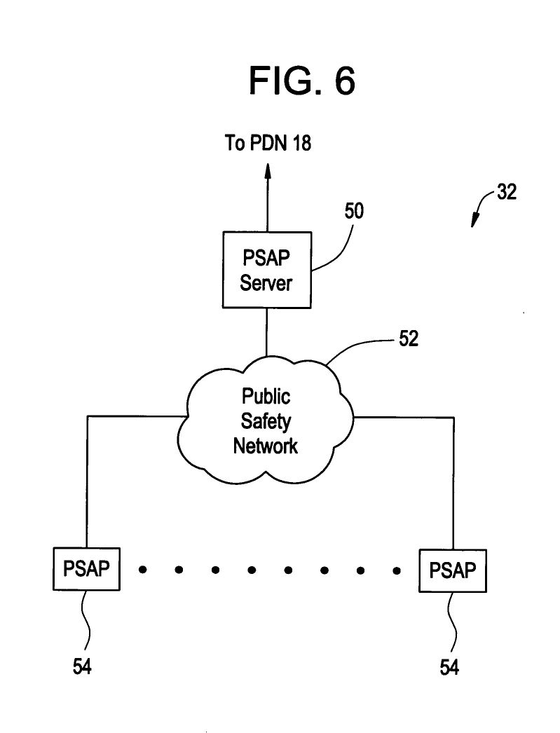

FIG. 6 illustrates an example of an emergency service provider system as the service provider 32. As shown, a public service answer point (PSAP) server 50 connects to the PDN 18. The PSAP server 50 receives the service related information and uses the information (e.g., location, callback number, call identity key) to route the call on to an appropriate PSAP 54 over a public safety network 52. The public safety network 52 may be a specific instance of a PDN or form part of the PDN 18. Because PSAPs 54 and public safety networks 52 are so well-known, they will not be described in detail for the sake of brevity. The PSAP 54 then communicates with the mobile station 10 to provide emergency services in the well-known manner. In the case of emergency services, a server in the public safety network not only determines where to deliver the emergency communication inside the public safety network, it also functions like a VoIP service provider to terminate a VoIP call at a PSAP 54 without the involvement of a commercial VoIP service provider. Furthermore, as mentioned above, the PSAP server 50 may include the surrogate home system 30.

Since the temporary IP address of the caller has been passed through to the PSAP, should the caller disconnect, the PSAP call taker can attempt to reestablish the call (Call back) using the IP address. The PSAP could also initiate communication at the beginning of the conversation to the caller's true home system for additional information regarding the caller and that this information may be useful in situations such as handoff or automatic roaming.

The processes described above apply for both subscriber initialized and non-subscriber initialized mobile stations. For example, independent of whether or not the user is subscribed to a particular VoIP service provider, this process would apply.

The user need not register, authenticate or provide any charging or billing information to a commercial service provider before invoking packet data service such as a packet data emergency service. It is anticipated that service providers may pay for the privilege of having there surrogate home system invoked by the visited ANC 12′ to handle a particular service request.

The processes described above also apply for wireless communication over licensed (e.g. cellular) or un-licensed (e.g., WiFi) radio channels available for public communication. If the RAN supports mobile users, then standard mobility management protocols would apply with a service the same as for any other mobile communication service to maintain the service as the caller moves or even roams between RANs. If the visited system were for wired communication, the same processes would apply. A significant difference internal to the process would be that the communication channel from the end user device to the service provider is fixed and mobility management protocols would not apply as for a mobile wireless channel.

The invention being thus described, it will be obvious that the same may be varied in many ways. Such variations are not to be regarded as a departure from the spirit and scope of the invention, and all such modifications as would be obvious to one skilled in the art are intended to be included within the scope of the present invention.

We claim:

1. A method of providing packet data services, comprising:
recognizing a communication from a user device as a service request; and
invoking a surrogate home system without accessing a home system for the user device if the recognizing step recognizes the communication as a service request, the surrogate home system configured to handle connecting the user device with a provider of the service requested.

2. The method of claim 1, wherein the recognizing step comprises:
receiving an identifier with the communication from the user device; and
determining that the identifier indicates a service request.

3. The method of claim 2, wherein the recognizing step further comprises:
sending service offerings to the user device along with associated service identifiers; and wherein
the receiving step receives one of the associated service identifiers.

4. The method of claim 2, wherein the determining step determines the identifier indicates a service request if the identifier matches known service identifier.

5. The method of claim 1, further comprising:
selectively obtaining, at the surrogate home system, service related information; and
directing, by the surrogate home system, communication from the user device to a provider of the service requested along with the obtained service related information.

6. The method of claim 5, wherein the directing step directs the communication over a packet data network.

7. The method of claim 5, wherein the selectively obtaining step obtains a location of the user device if the recognizing step recognizes the communication as a location based service request.

8. The method of claim 1, further comprising:
directing, by the surrogate home system, communication from the user device to a provider of the service requested along with the obtained service related information.

9. The method of claim 8, wherein the directing step directs the communication over a packet data network.

10. The method of claim 1, wherein the recognizing step recognizes whether the communication is an emergency services request.

11. The method of claim 1, wherein the recognizing step recognizes whether the communication is a location based service request.

12. A method of providing packet data services, comprising:
directing communication from a user device over a packet data network to a provider of a requested service without accessing a home system for the user device.

13. The method of claim 1, further comprising:
selectively obtaining service related information; and wherein
the directing step directs the communication from the user device to the provider of the service requested along with the obtained service related information.

14. The method of claim 13, wherein the selectively obtaining step obtains a location of the user device as the service related information.

15. The method of claim 1, wherein the service requested is emergency services.

16. The method of claim 1, wherein the service requested is a location based service.

17. A system for providing packet data services, comprising:
a visiting system recognizing a communication from a user device as a service request, the visiting system not being a home system for the user device, and the visiting system invoking a surrogate home system without accessing a home system for the user device if the visiting system recognizes the communication as a service request; and
the surrogate home system configured to handle connecting the user device with a provider of the service requested.

18. The system of claim 17, wherein the surrogate home system is configured to direct communication from a user device over a packet data network to the provider of a requested service without accessing the home system for the user device.

19. The system of claim 17, wherein the surrogate home system forms part of the service provider.
